(19) United States
(12) Patent Application Publication
(10) Pub. No.: US 2012/0283986 A1
(43) Pub. Date: Nov. 8, 2012

(54) System and Method for Measuring Positions

(76) Inventors: Ashok Veeraraghavan, Cambridge, MA (US); Amit Kumar Agrawal, Somerville, MA (US)

(21) Appl. No.: 13/100,092

(22) Filed: May 3, 2011

(51) Int. Cl. G06F 15/00

(52) U.S. Cl. 702/150

(57) ABSTRACT

A system for measuring a position includes a scale pattern encoding the position with a first resolution; a sensor for acquiring an input signal representing a portion of the scale pattern, the portion encoding a codeword shifted with a shift; and a processor for comparing the input signal with a model signal of the codeword to determine the shift, and to determine the position based on the codeword and the shift.

### FIELD OF THE INVENTION

This invention relates generally to measuring positions, and more particularly to a system and a method for measuring absolute or relative positions.

### BACKGROUND OF THE INVENTION

Measuring a position is an important task in industrial automation. Devices such as computed numerically controlled (CNC) machines, drill bits, robot arms or laser cutters need precision position measurements for feedback control. It is desirable to make position measurements at high sampling rates to enable the feedback control.

For example, optical encoders are used to measure absolute or relative positions. Typically, a scale having regularly spaced markings is used along with a sensor to measure the relative position between the two objects. Incremental linear encoders can only measure the relative position within the markings on the scale.

A relative position encoder keeps track of a number of marks traversed to determine the relative position. An absolute position encoder can determine the absolute position and is preferable in some applications, because the absolute position encoder does not require a memory and power to store a last position. In addition, the absolute position encoder can provide an absolute position at start up, while relative position encoder typically needs to locatea the start point, which takes time and may be impractical for some applications.

In a conventional absolute encoder, a unique code pattern of marks is used to measure each position. While such an encoder uses one scale, a position change is determined only when there is a change in the pattern. In this case, the resolution of the position estimate is the same as the resolution of the pattern.

Similarly, a conventional relative linear encoder can a measure linear position by optically detecting marks on a scale fixed parallel to a readhead. However, the resultant position resolution is limited by the resolution of the marks on the scale. For example, markings on the scale may be printed at a resolution of 40 microns, but the required accuracy may be 0.5 microns

To improve the resolution, one method uses two scales aligned in a detection direction with a periodic scale pattern, which includes, e.g., white and black marks. The scales are illuminated from one side, and a photodiode senses the light that passes through the two scales to the other side. As the scale moves relative to each other, the signal on the photodiode varies between a maximum and a minimum intensity value. A demodulation process is used to determine a phase of the signal, which is transformed into the relative position. The relative position can be recovered at a higher resolution than the scale resolution. In some design, one of the scales can be replaced by a grating inside the readhead.

However, such a design provides only the relative position. To have the ability of absolute positioning, some hybrid encoders use extra scales, which further increase the cost of the system. Such hybrid encoders measure incremental and absolute position using separate scales. However, the hybrid encoders need two readheads, a first for reading the incremental position, and a second for reading the absolute position.

Other convention encoders may use single scale with multiple tracks, or single track with multiple readheads, which may require a precise radiometric calibration of the sensed signal.

Therefore, it is desirable to use one scale and one readhead with a single position measurement device. It is also desirable to use a single device for reading relative and absolute position. It is also desirable to have the maximum information density packing position markings, e.g., bits or codewords onto the scale.

### SUMMARY OF THE INVENTION

It is an object of the invention to provide a system and a method for measuring an absolute and/or a relative position. It is another object of the invention to provide such a system and a method that are suitable to use a scale pattern with a high information density,i.e., high resolution absolute decoding. For example, a scale pattern with 100% information density results in continuous codewords, i.e., every consecutive bit sequence of the scale pattern corresponds to a unique codeword. It is also object of the invention to provide such a system and a method that can use both an incremental and an absolute scale patterns.

It is another object of the invention to provide such a system and a method that are suitable to use a single readhead with a single sensor. Also, it is another object of the invention to provide such a system and a method that can measure the position with the resolution higher than a resolution of the scale pattern.

Some embodiments of the invention are based on a realization that a codeword decoded from an input signal of a portion of a scale pattern can define an absolute or a relative position with a first resolution. However, a shift between the input signal and a model signal of the codeword can define a relative position with a second resolution, which is greater than the first resolution. Accordingly, the absolute or the relative position with the second resolution can be determined based on the codeword and the shift.

One embodiment of an invention discloses a system for measuring a position. The system includes a scale pattern encoding the position with a first resolution; a sensor for acquiring an input signal representing a portion of the scale pattern, the portion includes a codeword shifted with a shift; and a processor for comparing the input signal with a model signal of the codeword to determine the shift, and to determine the position based on the codeword and the shift.

The processor can be configured to execute a decoder module, a shift module and a position module, and wherein the decoder module decodes the codeword from the input signal, wherein the codeword defines an absolute position with a first resolution; the shift module determines the shift based on correlations between the input signal and a set of shifted signals, each shifted signal in the set of shifted signals is a uniquely shifted version of the model signal, wherein the shift defines a relative position with a second resolution, and wherein the second resolution is finer than the first resolution; and the position module determines the position based on the absolute position and the relative position, wherein the position is an absolute position with the second resolution.

The scale pattern can be formed by a set of marks including a first mark and a second mark of substantially same width, wherein a color of the first mark differs from a color of the second mark. The sensor can include a one-dimensional sensor or a two-dimensional sensor.

The scale pattern can be designed such that any portion of the scale pattern having a predetermined length is unique. For example, the portion of the scale pattern can include bits forming the codeword, and wherein the codeword is unique. Additionally or alternatively, the scale pattern can include symbols of bits, such that the symbols form the codeword, and wherein the codeword is unique. Also, the scale pattern can include a Debruijn sequence of bits or a M-sequence of bits.

The system can further include a light source arranged to illuminate the scale pattern; and a lens for directing the input signal to the sensor. For example, at least the sensor, the light source and the lens can form a readhead. The readhead can be arranged at a distance from the scale pattern. Additionally, the readhead can be positioned substantially parallel to the scale pattern or to have a rotation over to the scale pattern.

Another embodiment discloses a method for determining a position. The method includes decoding a codeword from an input signal representing a portion of a scale pattern; comparing the input signal with a model signal of the codeword to determine a shift between the model signal and the input signal; and determining the position based on the codeword and the shift. The steps of the method can be performed by a processor.

The method can also include computing correlations between the input signal and a set of shifted signals, each shifted signal in the set of shifted signals is a uniquely shifted version of the model signal; determining a correlation curve based on a result of the correlations; and determining the shift based on the correlation curve. The correlation curve can represent a relationship between a shift of the shifted signal and the input signal.

The method can also include selecting the shift corresponding to a maximum value of the correlation curve. The comparing step of the method can further include computing cross-correlations between the input signal and a set of shifted signals to produce a set of correlation scores; fitting a correlation curve into the set of correlation scores; and selecting the shift corresponding to a maximum value of the correlation curve.

The method can further include selecting a preliminary shift corresponding to a maximum correlation score in the set of correlation scores; determining a new set of shifted signals by shifting the model signal using shifts surrounding the preliminary shift; and updating the set of correlation scores with result of cross-correlations between the input signal and each shifted signal in the new set of shifted signal. Also, the method can include computing dot-products between the input signal and the shifted signals to determine the cross-correlations.

Yet another embodiment discloses a linear encoder. The linear encoder can include a decoder module for decoding a codeword from an input signal; a shift module for determining a shift between the input signal and a model signal of the codeword; and a position module for determining a position based on the codeword and the shift. The linear encoder can also include a scale pattern; and a sensor for acquiring the input signal representing a portion of the scale pattern.

### BRIEF DESCRIPTION OF THE DRAWINGS

FIG. 1 is a schematic of a system for measuring a position in accordance with some embodiments of the invention;

FIG. 2 is a block diagram of a system for measuring the position according to some embodiments of the invention;

FIG. 3 is a schematic of an example of a scale pattern;

FIG. 4 is a schematic of decoding a codeword;

FIG. 5 is a schematic of determining a model signal of an input signal;

FIG. 6 is a block diagram of a method for determining a shift according one embodiment of the invention;

FIG. 7 is a block diagram of a method for determining a shift according another embodiment of the invention;

FIG. 8 is a schematic of an example of the input signal, the model signal and a set of shifted signals;

FIG. 9 is an example of a correlation curve;

FIG. 10 is an example correlation curve subject to noise;

FIG. 11 is a flow chart of a method for determining the shift according to one embodiment of the invention; and

FIG. 12 is a schematic illustrating of some steps of the method of FIG. 11.

### DETAILED DESCRIPTION OF THE PREFERRED EMBODIMENT

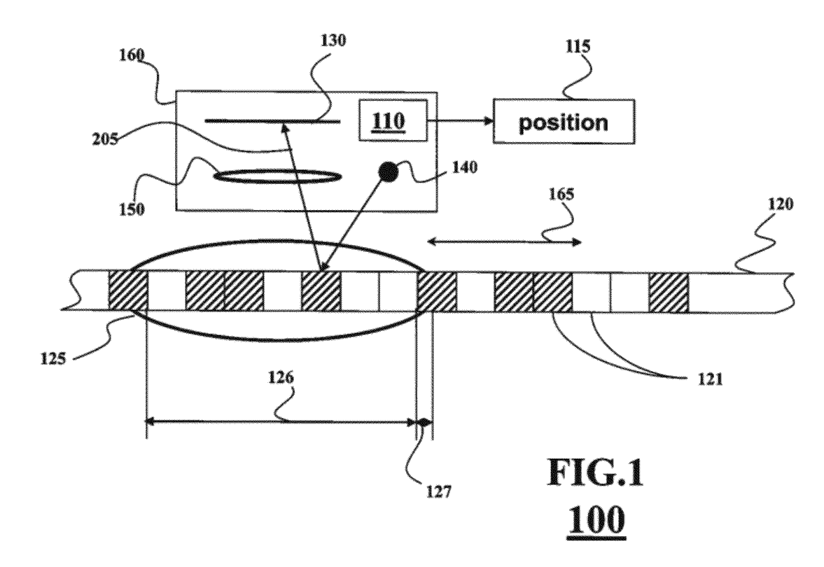

FIG. 1 shows a system 100 for measuring a position 115 in accordance with some embodiments of the invention. In one embodiment, the system 100 includes a scale pattern 120 with a pattern 121 including marks encoding the position with a first resolution, and a sensor 130 for acquiring an input signal 205 representing a portion 125 of the scale pattern. The system also includes a processor 110 for comparing the input signal with a model signal of a codeword to determine a shift between the input signal and the model signal, and to determine the position 115 based on the codeword and the shift.

In some embodiments, the system also includes a light source 140, e.g., a light emitting diode (LED), arranged to illuminate the scale pattern, and a lens 150 for directing the input signal to the sensor. For example, the LED can be arranged to achieve a coaxial illumination, or a non-coaxial illumination depending on reflectance properties of the scale pattern. In one embodiment, the sensor is one-dimensional and can include, e.g., a linear detector array. For example, the sensor includes a 1D line scan camera with N pixels. In some embodiment, N can be 2048. Alternatively, the sensor can be a two-dimensional.

In one embodiment, at least the sensor, the light source and the lens form a readhead 160. The readhead can also include the processor 110. The readhead 160 can be arranged at a distance from the scale pattern 120 and be configured to move 165 along the scale pattern. In one embodiment, the readhead is positioned substantially parallel to the scale pattern. Alternatively, the readhead can be rotated with respect to the scale.

In some embodiments, the system 100 measures the position 115 of the readhead, or an object associated with the readhead (not shown), with respect to the scale pattern. The position can be an absolute or relative position. In one embodiment, the change in the position 115 is caused by motion 165 of the readhead.

The scale pattern is formed by a set of marks including a first mark and a second mark of, e.g., substantially same width. The markings can black or white, reflecting or non-reflecting, grayscale, or colored.

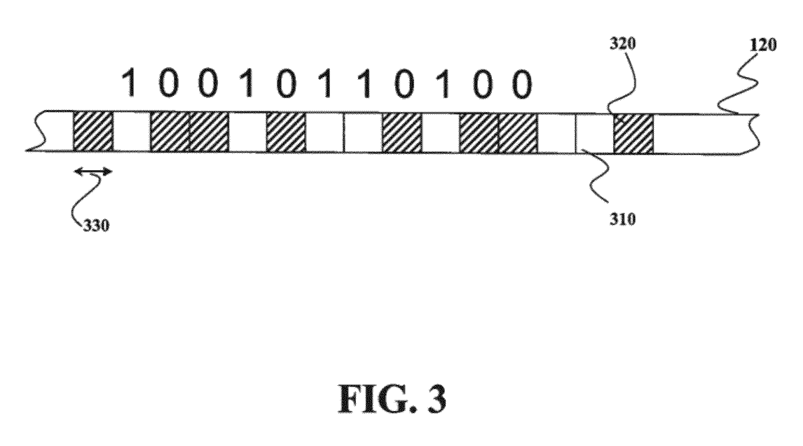

FIG. 3 shows an example of the scale pattern 120 encoding a sequence of bits. The sequence of bits is encoded by the first mark 310 and the second mark 320, e.g., by reflecting and non-reflecting marks, respectively. Each mark is B microns 330 wide. In one embodiment B is 20 microns. However, the width of the mark can be arbitrarily. Each mark encodes a bit of the scale pattern. For example, the reflective mark 310 encodes a q bit with, and the non-reflective mark 320 encodes a 0 bit. Other properties and values of the marks can be used.

In one embodiment, the sequence of bits defines a sequence of codewords. The scale pattern can be designed such that any portion of the scale pattern having a predetermined length is unique. For example, the portion of the scale pattern can include bits forming the codeword, and wherein the codeword is unique. Additionally or alternatively, the scale pattern can encode symbols of bits, such that the symbols form the codeword, and wherein the codeword is unique. For example, the pattern encodes a Debruijn sequence of bits, or a M-sequence of bits.

In one embodiment, the scale pattern is a relative scale, i.e., the scale pattern has alternating marks at some resolution B, e.g., 50 microns. The scale pattern encodes “‘101010 . . . ” for the relative scale, where 1 is encoded by, e.g., the white mark and 0 is encoded by, e.g., the black mark of the pattern. In alternative embodiment, the scale pattern encodes absolute positions, i.e., the scale pattern can be used to determine the absolute location with the resolution B.

Referring back to FIG. 1, when the sensor 130 acquires the input signal 205 representing the portion 125 of the scale pattern 120, the portion encodes a codeword 126. This codeword is used to determine a “coarse” position, i.e., the position with the first resolution. Typically, the first resolution corresponds to the width of the mark B. For example, if the width of the mark B is 20 microns, the coarse position can be determined with the resolution, i.e., precision, of 20 microns. However, a number of applications require a resolution to be much higher than the first resolution. For example, the resolution requirement could be 0.5 micron, which is 40 times smaller than the width B of 20 microns.

However, Applicants are recognized that the input signal is not necessarily ideally coincident with the model signal of the codeword, i.e., there is a shift between the ideal and the model signal. Moreover, this shift can be used to refine the coarse resolution, such that the position with a second resolution can be measured, wherein the second resolution is greater than the first resolution.

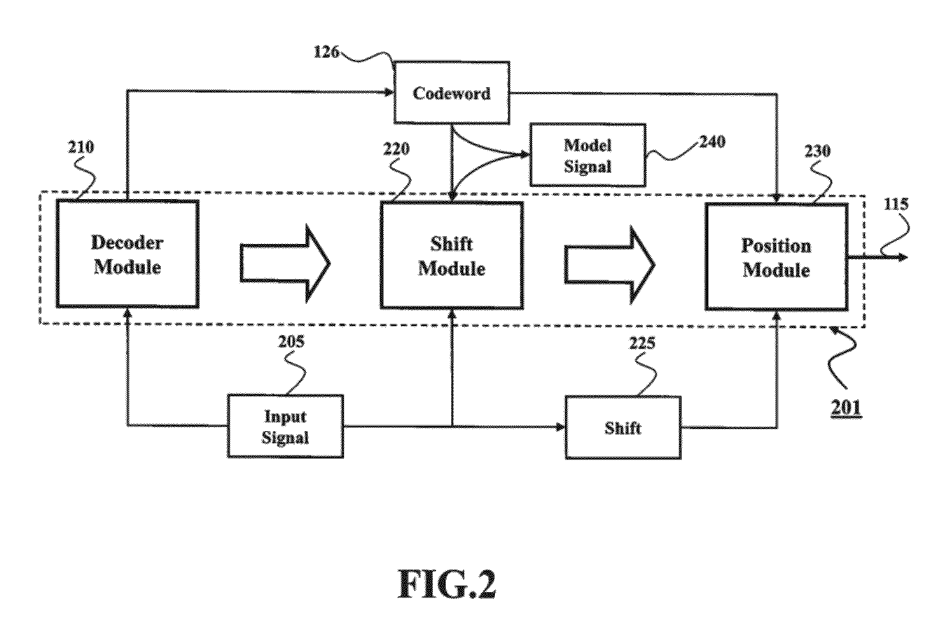

FIG. 2 shows a block diagram of a system for measuring position according to some embodiments of the invention. The system includes a processor 201 configured to execute a decoder module 210, a shift module 220 and a position module 230. The decoder module 210 decodes the codeword 126 from the input signal 205. The codeword 126 defines an absolute position with a first resolution. The shift module 220 determines a shift 225 based on comparison between the input signal 205 and a model signal 240 of the codeword 126. The model signal 240 is determined based on the codeword 126. The shift 225 defines a relative position with a second resolution, which is typically greater than the first resolution.

The position module 230 determines the position 115 based on the based on the codeword 126 and the shift 225. In some embodiment, the codeword defines the position as an absolute position with the first resolution, and the shift defines the position as a relative position with the second resolution, such that combination of the codeword and the shift defines the position as the absolute position with the second resolution.

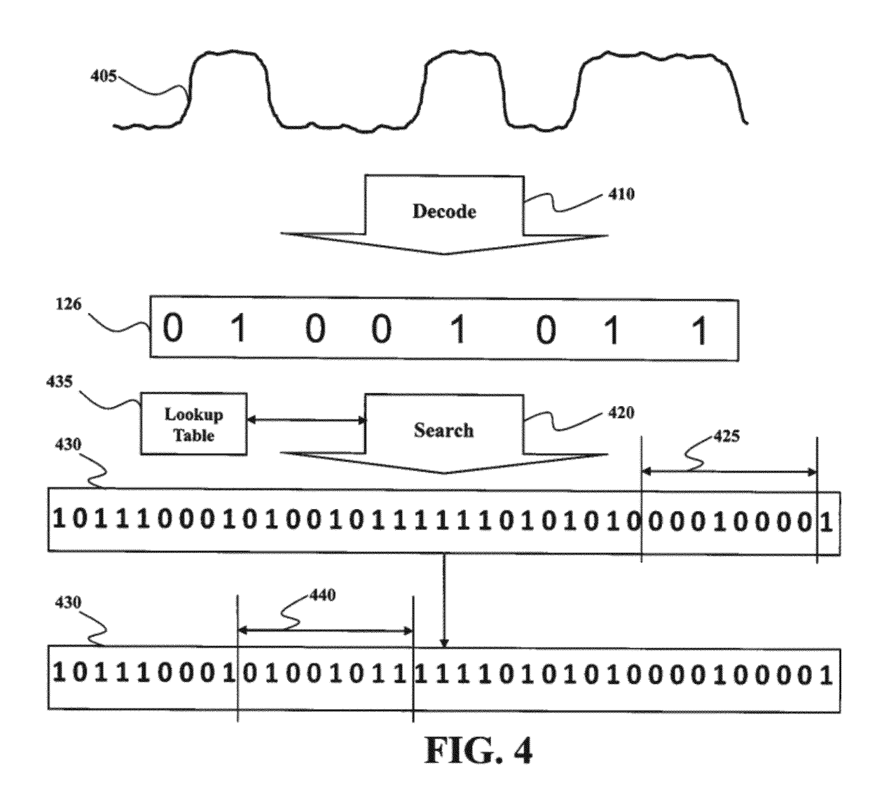

For example, in one embodiment the scale pattern 120 includes Debruijn sequences 430, as shown in FIG. 4. The Debruijn sequences have such a property that every sub-window 425 of length n is unique for a Debruijn sequence of length 2̂n. In one embodiment, the scale pattern includes 2̂(2̂(n-1)−n) of the Debruijn sequences having the length n.

For example, the length n of the Debruijn sequence can be determined as follows. For the scale pattern with a length of one meter with a half-pitch of B=20 microns, a sequence of 50,000 bit is required. A longer sequence of length 2¹⁶=65536 with an order of 16 can be used. This sequence can be truncated at the front or back to obtain the 50,000 long bit sequence.

For example, after the codeword 126 is decoded 410, e.g., by the decoder module 210, from the input signal 405. The position module 230 searches 420 the Debruijn sequences 430 to find a match 440. The match 440 defines the absolute position with the first resolution. For example, a look-up table 435 of length 2ⁿ can be used to determine the position within the Debruijn sequence.

In some embodiments, a field of view (FOV) of the sensor includes at least n bits. Thus, for example a half-pitch B=20 microns using a Debruijn sequence of order 16, the FOV should be at least 16*20=320 microns on the scale pattern. In one embodiment, the FOV is designed to be 1-2 mm for accuracy. For sampling of the Debruijn sequence, each bit is mapped to at least two pixels of the linear detector array of the sensor, which requires at least 32 pixels, which is less than the number of pixels in typical sensor. In various embodiments, a number of pixels K acquired by the sensor depends on a magnification of the lens 150.

Model Signal

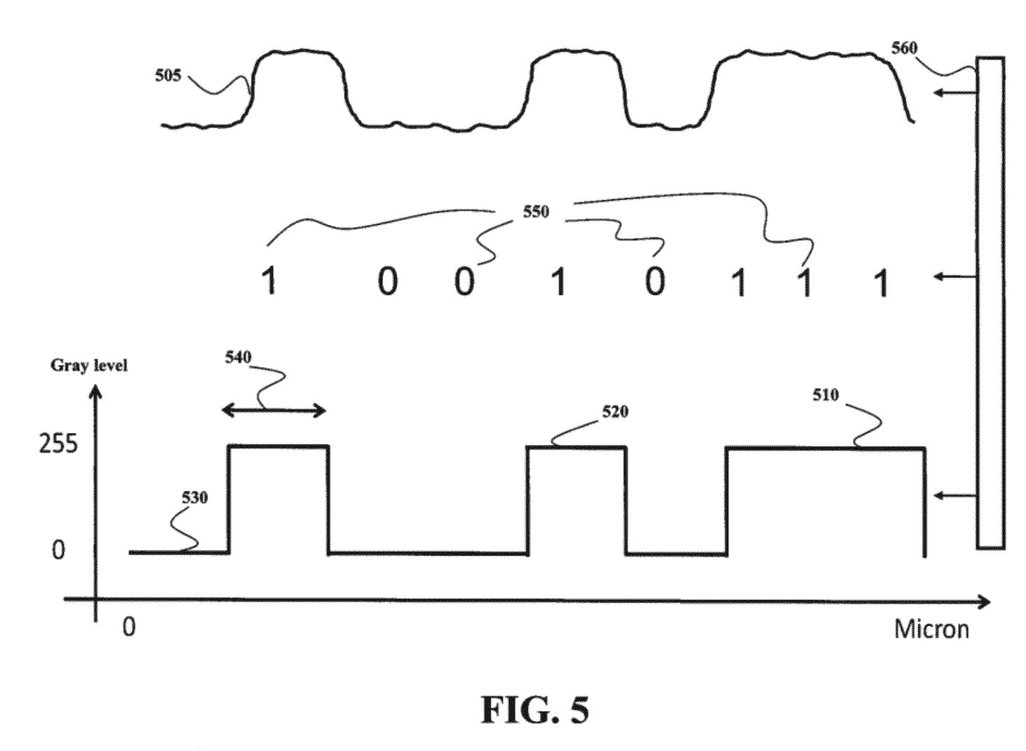

Generally, the intensities of a part of signal corresponding to the reflecting marks is large, e.g. 255 gray level for an 8 bit camera, and the intensities of the part of the signal corresponding to the non-reflecting marks is small, e.g., 0 gray level. Thus, ideally, the input signal of the scale pattern corresponds to a square waveform 510, which is high 520 for K pixels 540 and low 530 for K pixels 540 in dependence of the bits 550 of the codeword, as shown in FIG. 5, where the intensities are shown as a function of mark widths.

However, several factors can result in a deviation of the input image from the ideal word, resulting into the input image 505. These factors include but are not limited to dark noise caused by dead pixels, analog-to-digital converter errors, and bit errors in transmission, gamma and other non-linearity effects; fixed-pattern noise of the sensor, optical defocus, relative angular errors of scale positioning with respect to the sensor, scale magnification due to heat, and motion blur due to a relative motion between scale pattern and sensor.

Accordingly, some embodiments of the invention determine 560 the model signal 510 of the input signal 505. In one embodiment, the model signal is reconstructed from the bits 550 decoded from the codeword, i.e., the gray level 0 encodes a o bit, and the gray level 255 encodes a 1 bit. Additionally or alternatively, the model signal is determined as a binary waveform having the value of 1 or 0 for each K pixels 540. The shape of the waveform is the same as the encoded bits 550 of the codeword of the scale pattern.

In some embodiments, due to thermal effect changing the size of the scale, the input signal can undergo some magnifications or demagnifications, changing the number of pixels K for each mark. One embodiment determines the number of pixels K for each part of the input signal using a line fitting method. Also, if the amount of optical blur is known, then the blur of the input signal can be used to obtain a more accurate signal model. Similarly, estimates of noise can also be used to determine the model signal.

Determining Shift

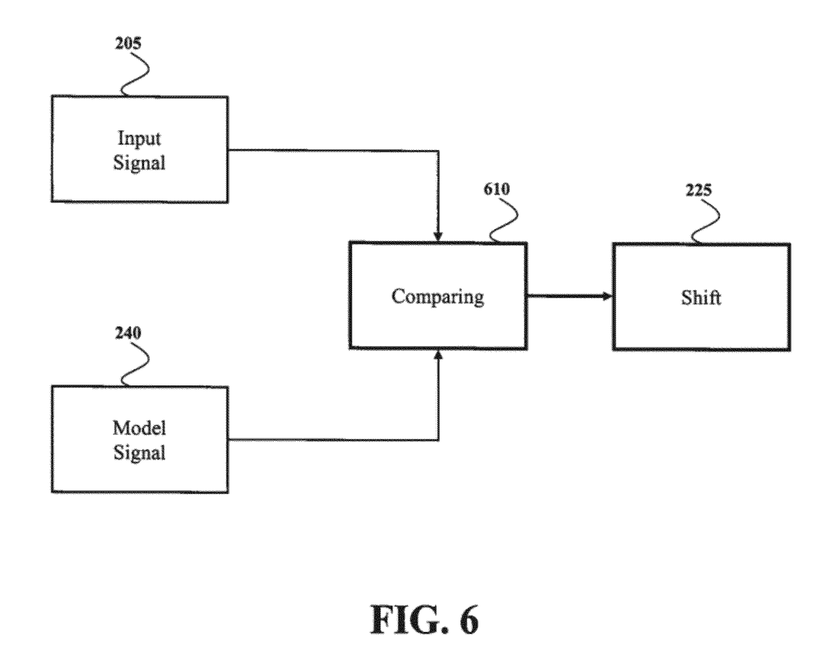

FIG. 6 shows a block diagram of a method for determining the shift 225, according some embodiments of the invention. The input signal 205 is compared 610 with the model signal 240 to determine the shift 225 between the model signal and the input signal. In some embodiments, the comparing 610 correlates the model signal with the input signal.

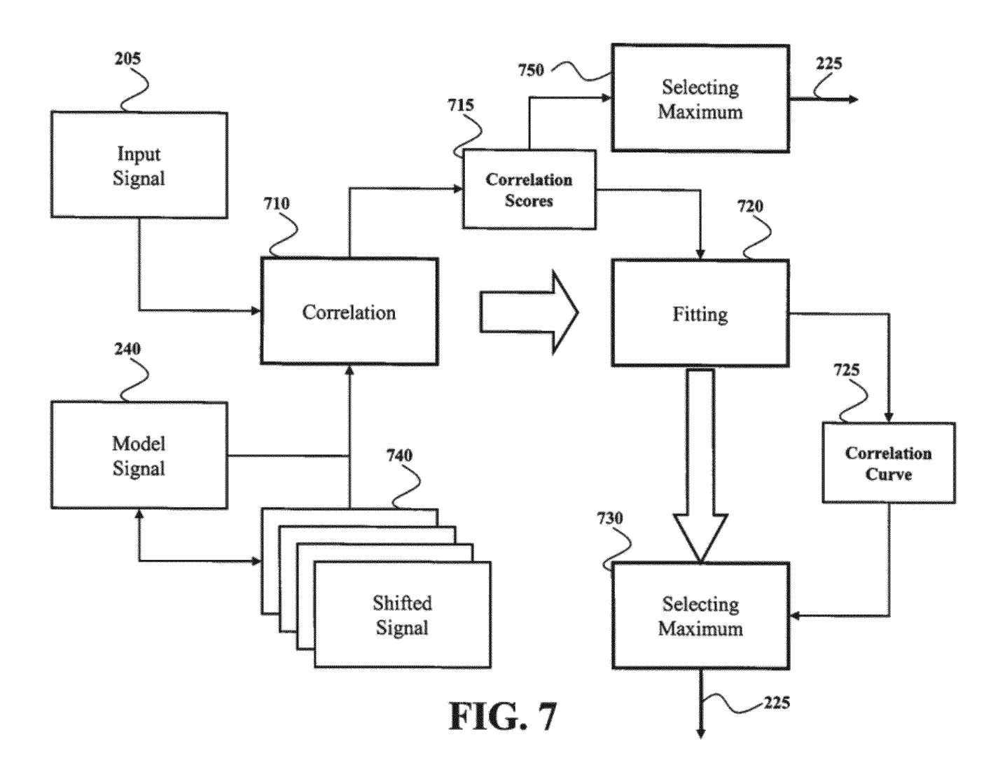

FIG. 7 shows a block diagram of a method for determining the shift 225 by computing correlations 710 between the input signal 205 and a set of shifted signals 740, each shifted signal in the set of shifted signals is a uniquely shifted version of the model signal 240. The correlations can be determined by averaging a dot product between the input signal and the shifted signals. In one embodiment, the set 740 includes the model signal 240. For example, digital signal processing (DSP) or a field-programmable gate array (FPGA) can be used to perform dot products and correlations.

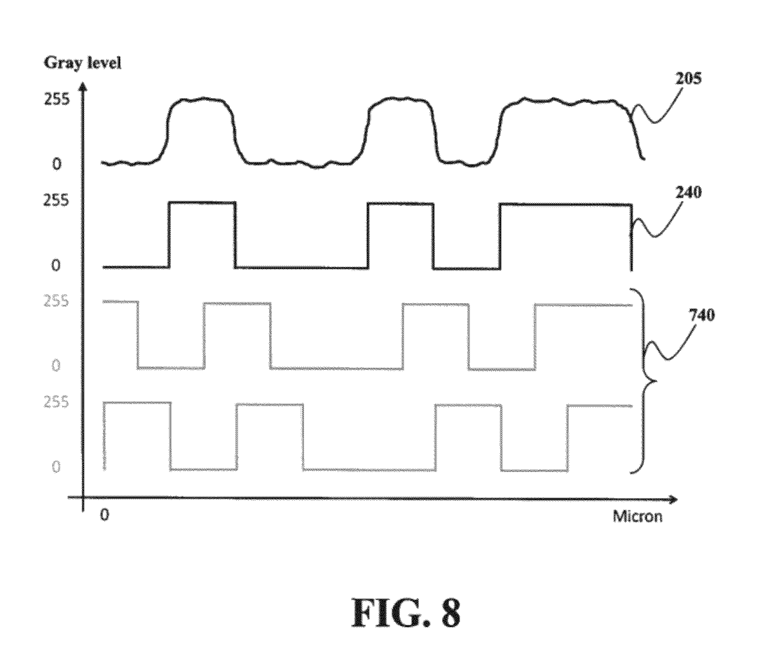

FIG. 8 shows an example of intensities of the input signal 205 as a function of mark width, the model signal 240 and the set of shifted signals 740. A number of shifted signals in the set 740 and the shifts of each shifted signal can be arbitrarily. For example, the number and the shifts can depend on a required second resolution.

This embodiment is based on a realization that correlation values vary linearly. The correlation reaches a maximum at a shift of zero and decreases as the shift increases. Accordingly, one embodiment selects 750 the shift of the shifted signal having maximum correlation score as the shift 225.

For an incremental scale pattern, the dot products vary between 0.5 and 0, if the signal is normalized between 1 and 0. This is because a shift of zero results in the dot product of signal with itself, which after averaging gives a value of 0.5. At a shift of K pixels, the dot product is zero.

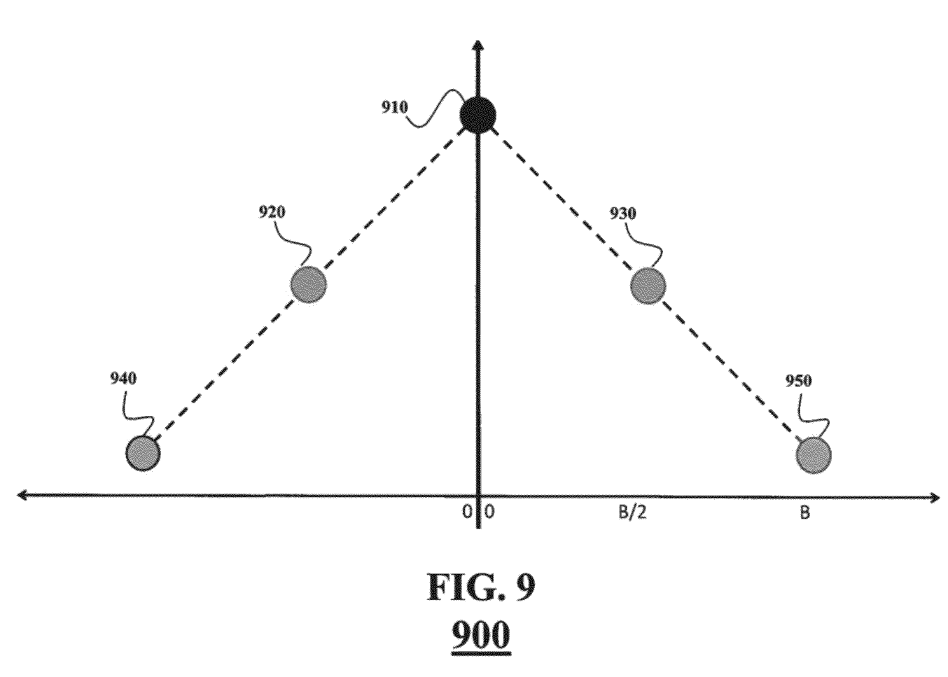

For the absolute scale pattern, the dot products vary between 0.5 and some nonzero value depending on the codeword. Thus, some embodiments determine the shift corresponding to allocation of the maximum value of the correlation scores. Importantly, the value of the maximum correlation score is not required. Specifically, one embodiment fits 720 the correlation scores 715 into a correlation curve 725, and selects 730 a shift corresponding to the maximum value of the correlation curve as the shift 225. FIG. 9 shows an example of such correlation curve 900. The correlation curve 900 is constructed by fitting the correlation values 910, 920, 930, 940, and 950. The shift associated with the location of the maximum correlation 910 is selected.

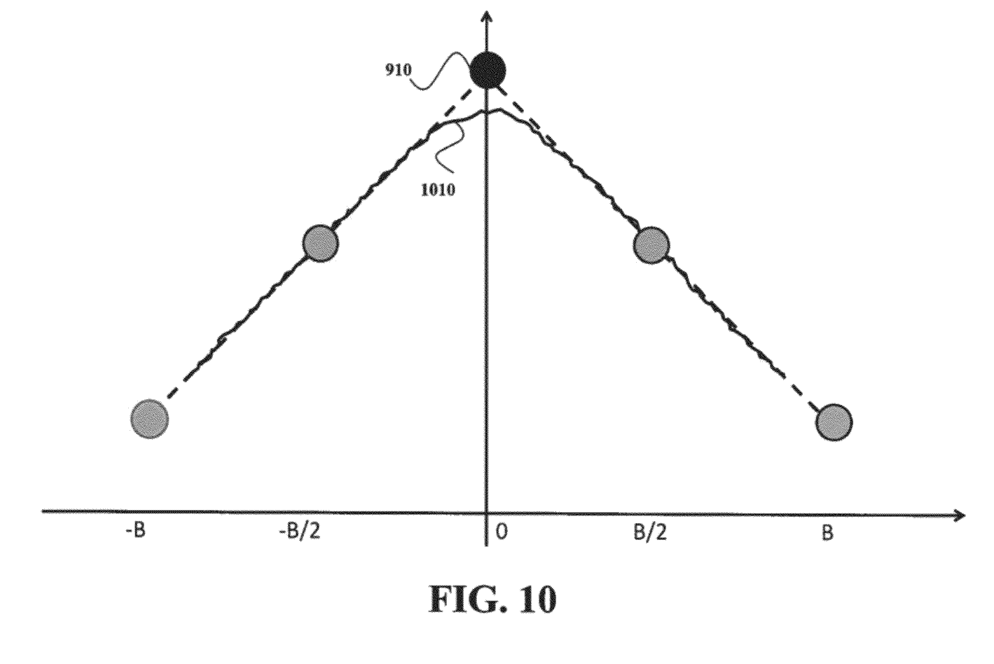

In presence of noise, blur, edge effects and other distortions, the correlation values are not be perfectly linear, as shown in FIG. 10. The peak of the correlation curve 1010 is smoother. However, the maximum of correlation 910 is not affected by the shape of the resulting correlation curve. In addition, the curve of correlation values does not remain linear at peak and sides, but is relatively linear in the middle.

Some applications require many correlations by shifting the model signal by a small amount each time to determine a matching shifted signal. In addition, in presence of noise and blur, detecting the correlation peak is difficult unless the number of samples close to the peak is large. It is desirable to minimize the number of correlations to reduce processing time.

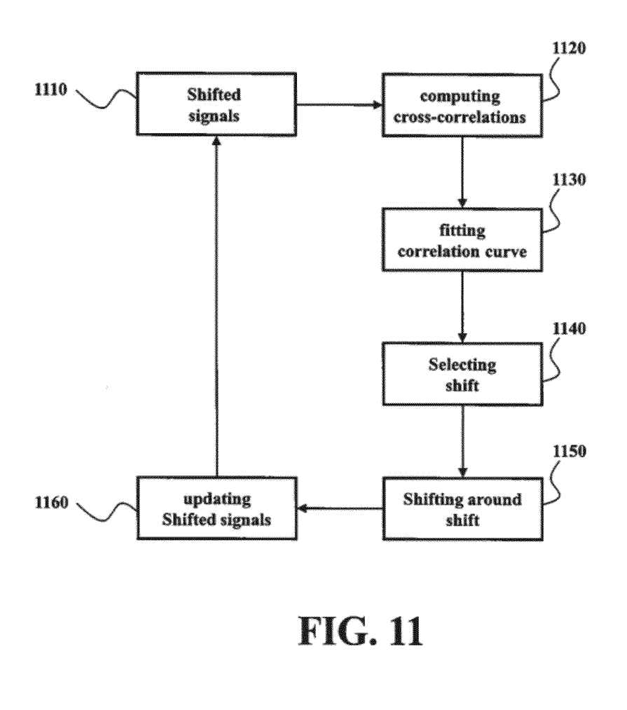

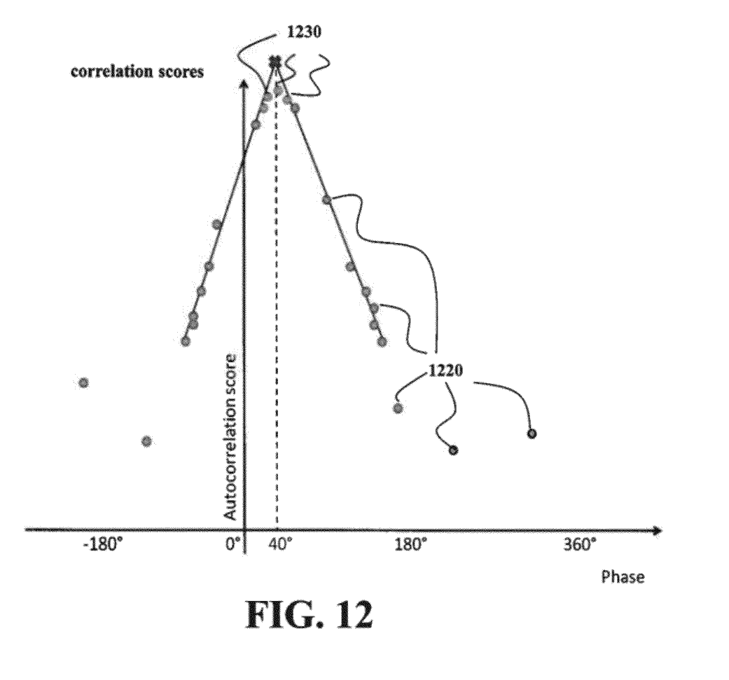

FIG. 11 shows a method for determining the shift according to one embodiment of the invention. The cross-correlations between the input signal and a set of shifted signals 1110 is determined 1120 to produce a set of correlation scores. The set of shifted signal 1110 may be not accurate, i.e., widely separated to get an initial set of correlation scores 1220 of the correlation curve, as shown in FIG. 12.

The correlation curve is fitted 1130 into the set of correlation scores to determine the shift 1140. Otherwise, the set of shifted signals is updated 1160 by shifting 1150 the model signal using shifts surrounding the shift, and the set of correlation scores 1230 is updated with result of cross-correlations 1120 between the input signal and each shifted signal in the updated set of shifted signal. The shift 225 can be determined as a phase of the input signal and converted to the relative position.

The above-described embodiments of the invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, minicomputer, or a tablet computer. Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium or multiple computer readable media, e.g., a computer memory, compact discs (CD), optical discs, digital video disks (DVD), magnetic tapes, and flash memories. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above.

Computer-executable instructions may be in many forms, such as program modules, executed by one or more computers or other devices. Generally, program modules include routines, programs, objects, components, and data structures that perform particular tasks or implement particular abstract data types. Typically the functionality of the program modules may be combined or distributed as desired in various embodiments.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

### Effect of the Invention

Embodiments of the invention enable to determine an absolute or relative position of an object using only one scale pattern, and with a resolution greater that the resolution of the scale pattern.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A system for measuring a position, comprising:
a scale pattern encoding the position with a first resolution;
a sensor for acquiring an input signal representing a portion of the scale pattern, the portion encoding a codeword shifted with a shift; and
a processor for comparing the input signal with a model signal of the codeword to determine the shift, and to determine the position based on the codeword and the shift.

2. The system of claim 1, wherein the processor is configured to execute a decoder module, a shift module and a position module, and wherein
the decoder module decodes the codeword from the input signal, wherein the codeword defines an absolute position with a first resolution;
the shift module determines the shift based on correlations between the input signal and a set of shifted signals, each shifted signal in the set of shifted signals is a uniquely shifted version of the model signal, wherein the shift defines a relative position with a second resolution, and wherein the second resolution is greater than the first resolution; and
the position module determines the position based on the absolute position and the relative position, wherein the position is an absolute position with the second resolution.

3. The system of claim 1, wherein the scale pattern is formed by a set of marks of substantially identical widths, wherein a color value of the marks varies in the scale pattern.

4. The system of claim 1, wherein the sensor is selected from a group consisting of a one-dimensional sensor and a two-dimensional sensor.

5. The system of claim 1, wherein the scale pattern is designed such that any portion of the scale pattern having a predetermined length is unique.

6. The system of claim 1, wherein the portion of the scale pattern encodes the codeword, and wherein the codeword is unique.

7. The system of claim 1, wherein the portion of the scale pattern encodes symbols of bits, such that the symbols form the codeword, and wherein the codeword is unique.

8. The system of claim 1, wherein the scale pattern encodes a Debruijn sequence of bits or a M-sequence of bits.

9. The system of claim 1, further comprising:
a light source arranged to illuminate the scale pattern; and
a lens for directing the input signal to the sensor.

10. The system of claim 9, wherein at least the sensor, the light source and the lens form a readhead, and wherein the readhead is arranged at a distance from the scale pattern.

11. The apparatus of claim 10, wherein the readhead is substantially parallel to the scale pattern.

12. The apparatus of claim 10, wherein the readhead is positioned to have a rotation with respect to the scale pattern.

13. A method for determining a position, comprising:
decoding a codeword from an input signal representing a portion of a scale pattern;
comparing the input signal with a model signal of the codeword to determine a shift between the model signal and the input signal; and
determining the position based on the codeword and the shift, wherein steps of the method are performed by a processor.

14. The method of claim 13, further comprising:
determining correlations between the input signal and a set of shifted signals, each shifted signal in the set of shifted signals is a uniquely shifted version of the model signal;
determining a correlation curve based on a result of the correlations; and
determining the shift based on the correlation curve.

15. The method of claim 14, further comprising:
selecting the shift corresponding to a maximum value of the correlation curve.

16. The method of claim 13, wherein the comparing further comprises:
determining cross-correlations between the input signal and a set of shifted signals to produce a set of correlation scores;
fitting a correlation curve into the set of correlation scores; and
selecting the shift corresponding to a maximum value of the correlation curve.

17. The method of claim 16, further comprising:
updating the set of shifted signals by shifting the model signal using shifts surrounding the shift; and
updating the set of correlation scores with result of cross-correlations between the input signal and each shifted signal in the new set of shifted signal.

18. The method of claim 16, further comprising:
computing dot-products between the input signal and the shifted signals to determine the cross-correlations.

19. A linear encoder, comprising:
a decoder module for decoding a codeword from an input signal;
a shift module for determining a shift between the input signal and a model signal of the codeword; and
a position module for determining a position based on the codeword and the shift.

20. The A linear encoder of claim 19, further comprising:
a scale pattern; and
a sensor for acquiring the input signal representing a portion of the scale pattern.
